(19) United States
(12) Patent Application Publication
(10) Pub. No.: US 2026/0059323 A1
(43) Pub. Date: Feb. 26, 2026

(54) SYSTEMS AND METHODS FOR NETWORK POLICY AND PARENTAL CONTROLS BASED ON SPATIAL AWARENESS

(71) Applicant: PLUME DESIGN, INC., Palo Alto, CA (US)

(72) Inventors: Saidhiraj AMURU, Telangana (IN); Badri Srinivasan SAMPATHKUMAR, Fremont, CA (US); Fahri DINER, Palo Alto, CA (US)

(21) Appl. No.: 18/814,705

(22) Filed: Aug. 26, 2024

(51) Int. Cl. H04W 12/63; H04W 12/37

(52) U.S. Cl. CPC H04W 12/63; H04W 12/37

(57) ABSTRACT

Disclosed are systems and methods that provide a computerized network management framework that provides novel network functionality for devices connected to and/or operating in proximity to wireless networks. The framework provides functionality for leveraging monitored and/or determined spatial awareness related to users and/or their devices in order to create intelligent network-based zones for which network management and/or connectivity can be provided, controlled and managed. The disclosed spatially intelligent zones can correspond to and/or be subject to applied network policies and/or parental controls, for which network activity within such zones can be managed and controlled. Accordingly, the disclosed framework can provide dynamic network capabilities and functionality based on the current position of the user within a location.

### FIELD OF THE DISCLOSURE

The present disclosure relates to network management, and more particularly, to a decision intelligence (DI)-based computerized framework for creating spatially intelligent network-based zones at a location for which network activity and/or device connectivity can be managed, controlled and/or facilitated.

### SUMMARY OF THE DISCLOSURE

Disclosed are computerized systems and methods for a network management framework that provides novel network optimization for wireless networks. As discussed herein, the disclosed systems and methods provide functionality for leveraging monitored and/or determined spatial awareness related to users and/or their devices in order to create intelligent network-based zones for which network management and/or connectivity can be provided, controlled and managed. According to some embodiments, the disclosed spatially intelligent zones can correspond to and/or be subject to applied network policies and/or parental controls, for which network activity within such zones can be managed and controlled. Accordingly, as discussed herein, the disclosed framework can provide dynamic network capabilities and functionality based on the current position of the user within a location.

By way of a non-limiting example, according to some embodiments, the disclosed framework can enable usage of certain applications on certain devices (e.g., watching TikTok™ videos or online content) only when the device is physically present in certain zones of a home. In another example, parents can set up parental controls for kids, such that they are only allowed to consume such content when they are in the company of parents and/or when they are not alone in their room. And, in another non-limiting example, entertainment and social applications can be restricted for employees of small businesses during certain times (e.g., business hours), which can be tied to particular business spaces within the office (e.g., no restrictions in the break room, but otherwise, such applications are restricted/blocked).

Thus, as discussed herein, the intelligent zones take into account network information and device information, as well as, but not limited to, temporal, spatial, logical, social and occupancy information related to activity at a location to build and implement spatially intelligent zones of network control and management.

According to some embodiments, a method is disclosed for creating spatially intelligent network-based zones at a location for which network activity and/or device connectivity can be managed, controlled and/or facilitated. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for creating spatially intelligent network-based zones at a location for which network activity and/or device connectivity can be managed, controlled and/or facilitated.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 illustrates an exemplary workflow according to some embodiments of the present disclosure;

FIG. 5 depicts an exemplary implementation of an architecture according to some embodiments of the present disclosure;

FIG. 6 depicts an exemplary implementation of an architecture according to some embodiments of the present disclosure; and

FIG. 7 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/a/g/n/ac/ax/be, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. According to some embodiments, as discussed herein, the disclosed framework operates to construct a three-dimensional (3D) map of a location (e.g., home, office, building, patio, and the like, and/or any other type of location that can host and provide a Wi-Fi network, for example) using network data (e.g., metrics and/or statistics) that can be collected via and/or in association with a Wi-Fi network. As provided below, such 3D mapping can include anchor points that can be utilized to pinpoint, track and/or monitor devices as they idle, traverse and/or move about the location, for which network management and controls can be based therefrom. As discussed below, the 3D mapping can be configured with a plurality of zones, where such zones may be configured with network controls, permissions and/or management tools that can cause and/or impact how devices operate on the network, if at all.

According to some non-limiting embodiments of the instant disclosure, wireless technologies inclusive of, but not limited to, WiFi (e.g., IEEE 802.11mc, 802.11az, and the like), Bluetooth Low Energy (BLE), Ultra-Wide Band (UWB)—based location/positioning, and the like, can be utilized to monitor network activity and/or spatial positioning of a user/user device within a location. According to some embodiments, as discussed herein, each wireless technology, inclusive of other known or to be known wireless technologies, can be leveraged to collect network data (or metrics), which can include data related to, but not limited to, received signal strength indicator (RSSI), signal-to-noise ratio (SNR), noise floor, interference, angle of arrival (AoA), angle of departure (AoD), time difference of arrival (TDOA), round trip time (RTT), observed time difference of arrival (OTDOA), and the like. As discussed herein, by intelligently analyzing and/or combining such compiled metrics, the disclosed systems and methods can identify the locations of the users/user device within the location, for which their corresponding zones in the location can be utilized to dictate how, and in which manner, they are able to perform network-based activities (e.g., access certain content, run certain applications, receive certain amounts of bandwidth, and the like).

Accordingly, as discussed below in more detail, usage of constructed 3D mappings (or 3D maps, used interchangeably) as a factor in determining permissions for network activity of a user device at location can enable advanced controls that tie to the spatial positioning and/or occupancy of the location, which is an added feature not currently considered by conventional network management tools. Such 3D mappings can depict, when rendered, which rooms users are in (and/or where, within such rooms, such user at), which can be based on, but not limited to, distance to particular anchor points within such rooms and/or zones (that reference or include such rooms). This, among other benefits, as provided below, can provide an indication of activity “hotspots”, or coverage holes (e.g., where no activity is occurring), and the like. For example—where are users congregating to access the Internet. As provided below, from this, specific controls (e.g., based on presets, received input and/or automatic determinations) can be implemented to, for example, tag safe zones, implement parental controls, modify network connectivity, and the like, or some combination thereof.

Thus, as provided below, the 3D mapping can provide a spatial topology map of anchor points mapped to a 3D model of the location. The 3D spatial positioning of devices can be mapped to the 3D mapping of the network and/or 3D location model. This, for example, can enable and/or provide an indication of the network topology (e.g., which access point (or anchor point) is a user device connected to, which can be visualized via the 3D mapping).

In another non-limiting example, the disclosed framework, via the 3D mapping construction and implementation, can enable and/or provide an indication of what types of applications are being used in particular points of the location (e.g., Zoom® calls in the home office, games in the living room, TV/streaming in the kitchen, and the like). Thus, the 3D mapping can provide an application mapping in addition to a device mapping, which can be realized and visualized via the 3D mapping, as discussed herein.

In yet another non-limiting example, the disclosed framework, via the 3D mapping construction and implementation, can perform accurate and efficient localization and/or device discovery operations inside the location's premises.

Accordingly, as discussed herein in some embodiments, the disclosed framework can provide dynamic network capabilities and functionality based on the current positioning of users/user devices within a location, which can be targeted, driven, modified and/or curated via the network topology and/or operational status provided by the 3D mapping.

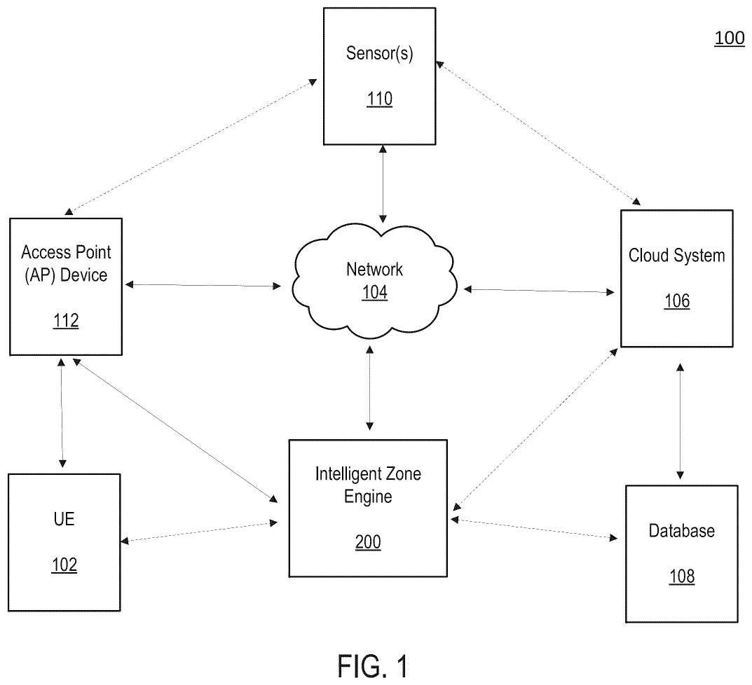

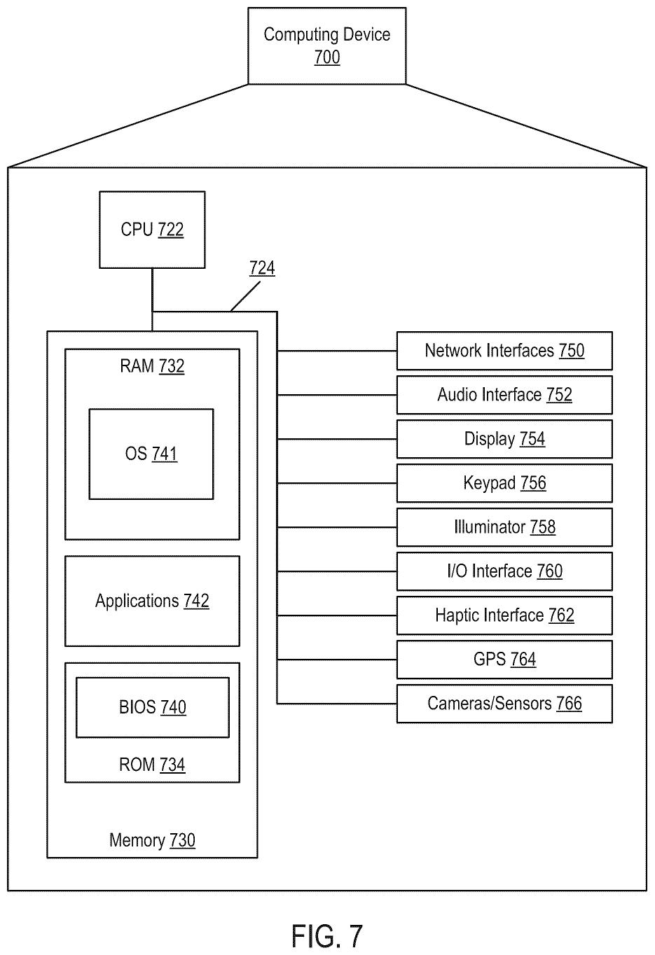

With reference to FIG. 1, system 100 is depicted which includes user equipment (UE) 102 (e.g., a client device, as mentioned above and discussed below in relation to FIG. 7), AP device 112, network 104, cloud system 106, database 108, sensors 110 and intelligent zone engine 200. It should be understood that while system 100 is depicted as including such components, it should not be construed as limiting, as one of ordinary skill in the art would readily understand that varying numbers of UEs, AP devices, peripheral devices, sensors, cloud systems, databases and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, sensor, Internet of Things (IoT) device, wearable device, autonomous machine, smart television, media streaming device, game console, and any other device equipped with a cellular or wireless or wired transceiver.

In some embodiments, peripheral devices (not shown) can be connected to UE 102, and can be any type of peripheral device, such as, but not limited to, a wearable device (e.g., smart ring, smart watch, for example), printer, speaker, sensor, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

According to some embodiments, AP device 112 is a device that creates and/or provides a wireless local area network (WLAN) for the location. According to some embodiments, the AP device 112 can be, but is not limited to, a router, switch, hub, gateway, extender and/or any other type of network hardware that can project a WiFi signal to a designated area. In some embodiments, UE 102 may be an AP device.

According to some embodiments, sensors 110 can correspond to any type of device, component and/or sensor associated with a location of system 100 (referred to, collectively, as “sensors”). In some embodiments, the sensors 110 can be any type of device that is capable of sensing and capturing data/metadata related to activity of the location. For example, the sensors 110 can include, but not be limited to, cameras, motion detectors, door and window contacts, heat and smoke detectors, passive infrared (PIR) sensors, time-of-flight (ToF) sensors, and the like. In some embodiments, the sensors can be associated with devices associated with the location of system 100, such as, for example, lights, smart locks, garage doors, smart appliances (e.g., thermostat, refrigerator, television, personal assistants (e.g., Alexa®, Nest®, for example)), smart phones, smart watches or other wearables, tablets, personal computers, and the like, and some combination thereof. For example, the sensors 110 can include the sensors on UE 102 (e.g., smart phone) and/or peripheral device (e.g., a paired smart ring). In some embodiments, sensors 110 can be associated with any device connected and/or operating on cloud system 106 (e.g., a cloud-based device, such as a server that collects information related to the location, for example).

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a smart home or network provider (e.g., Plume Design®, for example), which has associated network resources hosted on the internet or private network (e.g., network 104), which enables (via engine 200) the network management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, AP device 112, sensors 110, and the services and applications provided by cloud system 106 and/or intelligent zone engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

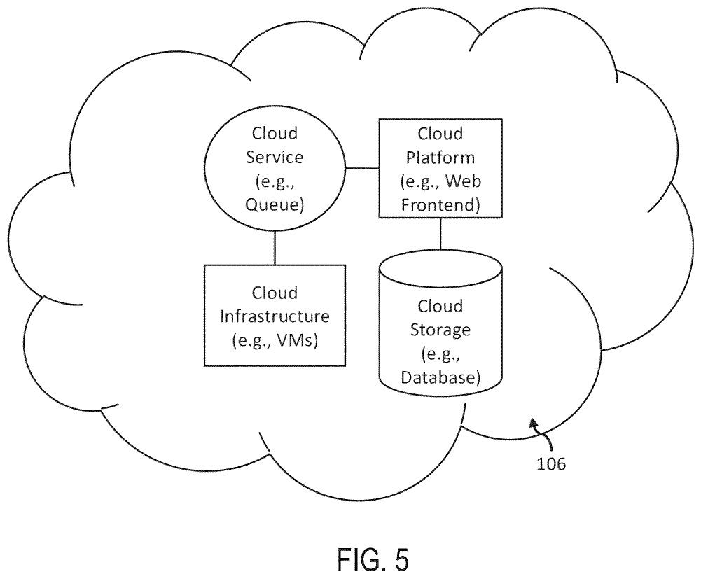

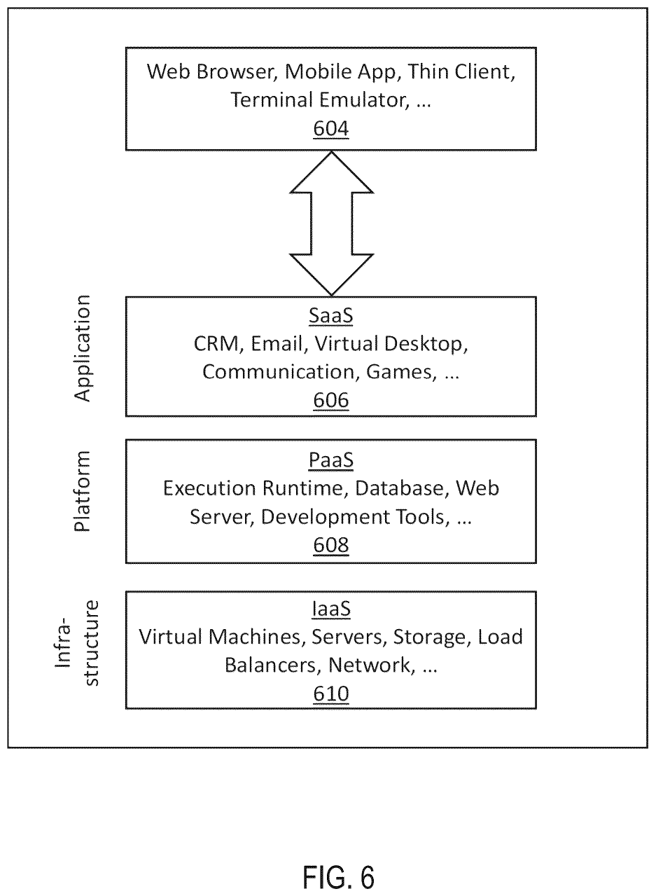

Turning to FIGS. 5 and 6, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 610, platform as a service (PaaS) 608, and/or software as a service (SaaS) 606 using a web browser, mobile app, thin client, terminal emulator or other endpoint 604. FIGS. 5 and 6 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, structured query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Intelligent zone engine 200, as discussed above and further below in more detail, can include components for the disclosed functionality. According to some embodiments, intelligent zone engine 200 may be a special purpose machine or processor, and can be hosted by a device on network 104, within cloud system 106, on AP device 112 and/or on UE 102. In some embodiments, engine 200 may be hosted by a server and/or set of servers associated with cloud system 106.

According to some embodiments, as discussed in more detail below, intelligent zone engine 200 may be configured to implement and/or control a plurality of services and/or microservices, where each of the plurality of services/microservices are configured to execute a plurality of workflows associated with performing the disclosed network management. Non-limiting embodiments of such workflows are discussed and provided below.

According to some embodiments, as discussed above, intelligent zone engine 200 may function as an application provided by cloud system 106. In some embodiments, engine 200 may function as an application installed on a server(s), network location and/or other type of network resource associated with system 106. In some embodiments, engine 200 may function as an application installed and/or executing on AP device 112 and/or UE 102 (and/or sensors 110). In some embodiments, such application may be a web-based application accessed by AP device 112 and/or UE 102, and/or devices associated with sensors 110 over network 104 from cloud system 106. In some embodiments, engine 200 may be configured and/or installed as an augmenting script, program or application (e.g., a plug-in or extension) to another application or program provided by cloud system 106 and/or executing on AP device 112, UE 102 and/or sensors 110.

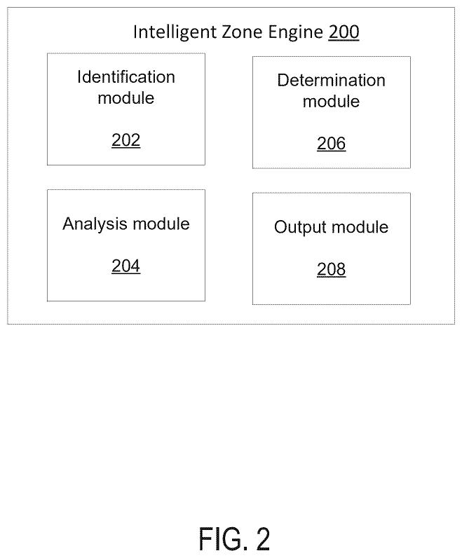

As illustrated in FIG. 2, according to some embodiments, intelligent zone engine 200 includes identification module 202, analysis module 204, determination module 206 and output module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

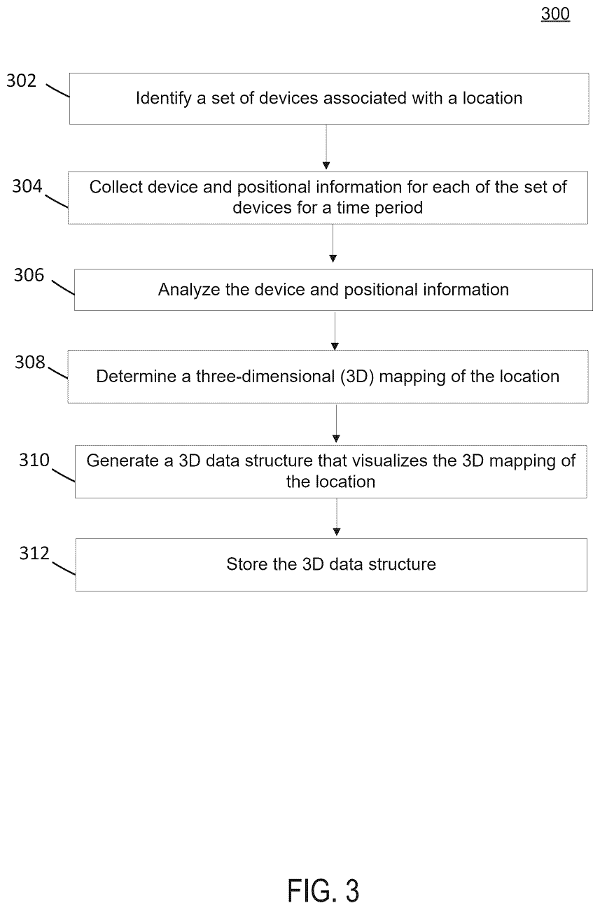

Turning to FIG. 3, Process 300 provides non-limiting example embodiments for the disclosed network management framework. As discussed herein, the disclosed implementation for Process 300 relates to the construction of the 3D mapping of the location.

As discussed above and in more detail herein, in some embodiments, a set of devices can be defined as anchor points in the location. Such anchor points can be used to send signals to users/user devices that need to be localized to specific regions/zones/positioned. In some embodiments, such users/user devices can be used to collect data from the anchor points; and/or in some embodiments, such anchor points can function to collect data from the user/user devices.

Accordingly, in some embodiments, the collected data, as discussed below, can be analyzed to develop the 3D mapping which can address operational use cases (as provided above—for example, application management, device localization, and the like). In some embodiments, the analysis, determinations and/or deployment of controls based on such determinations can be performed via engine 200, which as provided above (at least in FIG. 1) can be operating in the cloud, at a device (e.g., user device or AP), and the like, or some combination thereof. Thus, for example, the analysis and determinations can be performed via engine 200 operating in the cloud; and in another example, engine 200 may be operating at an AP(s) (e.g., anchor point, for example).

Thus, as provided below via steps of Process 300, in some embodiments, creating a 3D mapping of a network at a location, such as a building, involves several steps, including defining zones like rooms and implementing specific policies per zone. Initially, data collection is critical. This can include, for example, obtaining architectural blueprints or floor plans, utilizing 3D scanning technologies like LiDAR, and deploying sensors and IoT devices for real-time environmental data. With this data, the framework can create a detailed 3D model using AI/ML 3D modeling tools, which may integrate GIS data for accurate positioning.

In some embodiments, as provided below, the framework can define zones within the 3D mapping by identifying different rooms and areas, and establishing virtual boundaries for each zone. For example, such zones can be named/labeled and assigned attributes, such as room dimensions, purpose, occupancy limits, network controls, parental controls, and the like. Such zone definitions can involve mapping the network infrastructure, including the locations of network devices (e.g., routers, access points, switches), other network infrastructure connecting such devices, and the like. The framework can therefore define the coverage areas of Wi-Fi or other network types within the 3D mapping and assign IP subnets and VLANs to different zones for segmentation, for example.

In some embodiments, implementing policies per location and/or per zone of the location can involve several aspects, which can be tied to particular zones, device types, time periods, location types, and the like. For access control, the framework can define user and/or device roles and access levels, and implement authentication mechanisms. Security policies can include, for example, applying firewall rules specific to zones and deploying intrusion detection systems and intrusion prevention systems (IDS/IPS) to monitor traffic. In some embodiments, quality of service (QoS) policies involve allocating bandwidth and prioritizing traffic types based on zone requirements. In some embodiments, parental control policies can be integrated into such other policies and/or assigned to such zones to control and/or limit actions and/or permissions of certain device types and/or device identifiers (IDs), for example.

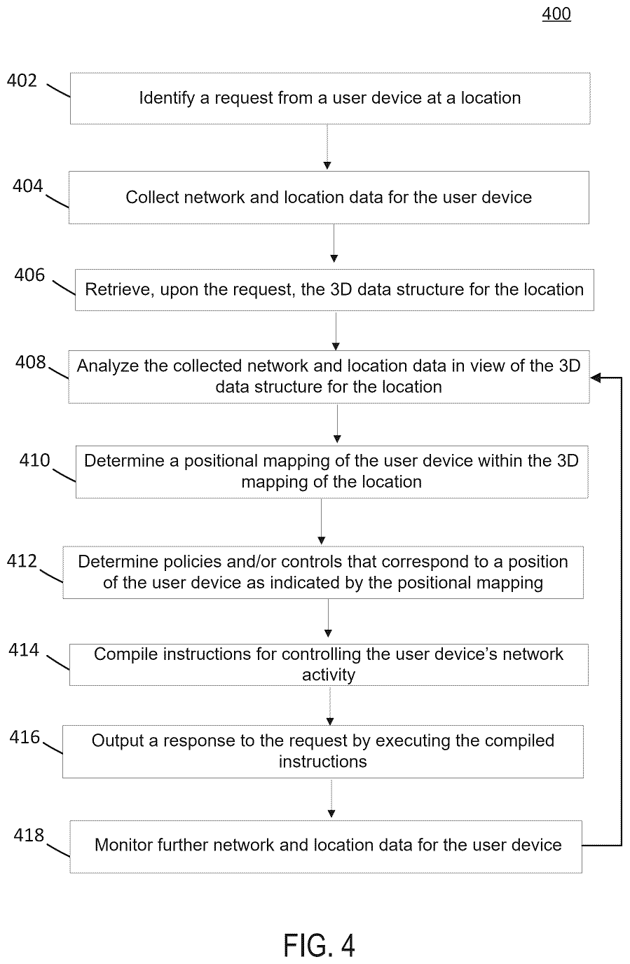

And, as provided below in more detail related to Process 400 of FIG. 4, monitoring and managing such 3D mapping can involve real-time monitoring of network performance, network conditions, and occupancy, among other factors. For example, in an office building, the 3D mapping can include zones such as offices, conference rooms, and common areas. Network mapping can include Wi-Fi access points with defined VLANs for different zones. Policies can allocate high bandwidth and prioritize video conferencing traffic in conference rooms, apply standard security in offices, and provide limited guest Wi-Fi in common areas. Real-time monitoring and management can adjust HVAC settings based on occupancy detected through sensors. This comprehensive approach ensures efficient, secure, and optimized network and resource management per zone.

It should be understood that while the discussion herein with reference to Process 300 of FIG. 3 and Process 400 of FIG. 4 will be with reference to a WiFi network, it should not be construed as limiting, as one of skill in the art would readily understand that any type of known or to be known communication network (e.g., network 104, discussed supra) can be utilized without departing from the scope of the instant disclosure.

According to some embodiments, Steps 302 and 304 of Process 300 can be performed by identification module 202 of intelligent zone engine 200; Step 306 can be performed by analysis module 204; Step 308 can be performed by determination module 206; and Steps 310-312 can be performed by output module 208.

According to some embodiments, Process 300 begins with Step 302 where engine 200 can identify a set of devices associated with a location. As discussed above, the set of devices can include, but are not limited to, APs, UEs and/or other devices at the location. In some embodiments, as discussed above, at least a portion of the set of devices can be assigned and/or identified as anchor points for the location. For example, if the location is a home, and has 3 mobile devices, 1 laptop, 1 PC, 2 APs and 2 extenders, then the PC, each AP and each extender can be set as an anchor point.

Accordingly, as discussed herein, each anchor point can have known coordinates in the 3D space, which can be pre-surveyed and/or determined using AI/ML high-precision techniques (e.g., real-time kinematic (RTK) modelling, post-processing kinematic (PPK) modelling, terrestrial laser scanning (TLS), inertial navigation systems (INS), and the like. Such anchor points, as used below, can provide a reference framework to which all other data points can be compared (e.g., compute distances and positions of UEs to at least one anchor point).

In some embodiments, Step 302 can further include information related to the location, which can include, but not be limited to, a layout, floorplan, blue prints, and the like, which can be provided as a file, object, data structure, input and/or other form of information used as input to engine 200.

In Step 304, engine 200 can collect information for each of the devices for a time period. The time period can be utilized to understand a ground truth of the location, so as to understand which devices are associated with the location and which are not. For example, device and/or location information related to a guest's mobile phone may not provide viable information for the 3D mapping of the location as their presence/occupancy in the location may be brief. Thus, in some embodiments, the time period can be set by a user, administrator, service provider, engine 200, and the like, or some combination thereof, and can be a value to ensure devices are confirmed as being associated with the location (e.g., 1 hour, 1 day, 1 week, for example).

In some embodiments, the collected information can provide device and positional information for the set of devices. In some embodiments, the device information, for each device, can include data/metadata related to, but not limited to, device type, device ID, device version, device manufacturer, applications installed thereon, current operating system (OS), user accounts associated therewith, and the like. In some embodiments, the positional information, for each device, can include, but is not limited to, the current location of the device, movements (e.g., beyond a threshold distance) of the device, starting point and ending point (as per the time period), coordinates in x, y and z directions, and/or GPS data of such movements and/or current position, and the like.

As discussed above, such collected information can include and/or be based on, but not limited to, for each device, RSSI data, SNR data, noise floor data, interference data, AoA data, AoD data, TDOA data, RTT data, OTDOA data, and the like. For example, RSSI can be converted into distances via AI/ML models (e.g., free space path loss model, for example) to determine position of a UE to an anchor point AP.

In some embodiments, the collected information, inclusive of the positional information of a device can be determined via triangulation/trilateration, where engine 200 can use triangulation or trilateration mechanisms to estimate the position of a device based on the distances from multiple known locations (e.g., anchor points, such as Wi-Fi APs or beacons, for example).

And, in some embodiments, such collected information from Step 304 can be stored in database 108, as discussed above.

In Step 306, engine 200 can analyze the collected information for each device. In some embodiments, such analysis can be performed via engine 200 executing a specific trained artificial intelligence (AI)/ML model, a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may be configured to utilize one or more AI/ML techniques selected from, but not limited to, computer vision, feature vector analysis, decision trees, boosting, support-vector machines, neural networks, nearest neighbor algorithms, Naive Bayes, bagging, random forests, logistic regression, and the like.

For example, engine 200 can implement a simultaneous localization and mapping (SLAM) model to create a 3D mapping for the location, as provided below. In some embodiments, engine 200 can deploy models/algorithms such as Kalman filters or particle filters to correct sensor inaccuracies from the data collection operations, which can improve overall map precision.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
c. apply the trained model to process the newly received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

Thus, based on the analysis of the collected data, in Step 308 engine 200 can determine a 3D mapping of the location. The 3D mapping of the location, which includes information related to and/or providing a network topology of the anchor points (e.g., APs, for example) and layout of the location (e.g., floorplan/blueprints, for example), can be compiled, created and/or generated as a data structure, item, object and/or other type of executable file, which can provide and/or render the 3D mapping for display, as in Step 310.

Accordingly, as discussed herein, Steps 308 and 310's operation cause the creation of a comprehensive 3D mapping data structure for network infrastructure at the location which provides, among other types of information, detailed information about the physical, network and logical aspects of the network and location. In some embodiments, the 3D data structure includes information related to precise 3D coordinates for all network devices, including switches, routers, access points, and servers. In some embodiments, each device entry includes not just its location, but can also detail specifications such as manufacturer, model, hardware details, operating system version, and performance metrics, and the like. The data structure can also capture intricate details about connections between devices, specifying the type of connection, cable specifications, and real-time performance data like bandwidth utilization and latency, for example.

In some embodiments, the data structure can include information related to the location's environmental elements, which can be related to, but is not limited to, walls, floors, ceilings, and/or other physical objects/fixtures in the location. Such information can include, but not be limited to, their dimensions, materials and properties that might affect signal propagation. Thus, the 3D mapping can extend to building-wide information, capturing floor plans, overall dimensions, and even GPS coordinates. In some embodiments, for wireless networks, the 3D mapping can include RF information, such as coverage heat maps and interference sources.

In some embodiments, the 3D mapping can include additional information besides networking equipment—such as, location related infrastructure like power systems, cooling arrangements, and security installations.

Accordingly, the 3D mapping can be configured to be segmented or partitioned into zones, which can be based on, but not limited to, floors, rooms, closets, staircases, patios, attics, and the like. Indeed, in some embodiments, the configuration of the 3D mapping's zones can correspond to positions of anchor points, APs, UEs, structures in the location, occupancy of the resident users, and the like, or some combination thereof. Accordingly, zones may be capable of changing or being modified according to determined patterns of activity within the location (which can be based on, but not limited to, a time of day, date, activity on the network, occupants currently at the location, UEs connected to APs, and the like).

Thus, the 3D mapping data structure provides capabilities, upon its rendering and/or implementation, for creating detailed 3D visualizations that offer insights into the complex interplay between physical infrastructure, logical network design, and environmental factors. This, as provided below in relation to Process 400 of FIG. 4, can enable a dynamic, automatic customized user experience that adheres to applied policies at and through the location, across the zones of the location. For example, the 3D mapping can be generated for display via geographic information system (GIS) software executed by engine 200.

And, in Step 312, engine 200 can store the generated 3D data structure in database 108, as discussed above, which can be retrieved and utilized, as discussed in more detail below in reference to Process 400 of FIG. 4.

Turning to FIG. 4, Process 400 depicts non-limiting example embodiments for implementing the disclosed systems and methods for purposes of curating dynamic, permission-based, spatially-configured network experiences for a user at a location.

According to some embodiments, Steps 402-406 and 418 of Process 400 can be performed by identification module 202 of intelligent zone engine 200; Step 408 can be performed by analysis module 204; Step 410 and 412 can be performed by determination module 206; and Steps 414 and 416 can be performed by output module 208.

According to some embodiments, Process 400 begins with Step 402 where engine 200 can identify a request from a user device at the location. The request can correspond to and/or be based on, but not limited to, the device entering the location (e.g., the user returning home and upon a sensor detecting they have entered the front door, for example; or outside the location but capable of connecting to the WiFi network of the location (e.g., 5 feet outside, or whatever the network reach of the WiFi is, as based on AP positioning within the location), the device entering a room or zone (as detected by a sensor, for example), the user logging into an account, the device requesting a network resource (e.g., application, web page, web site, file, portal, another device, storage, network location, and the like), the device initiating or opening an application, and the like, or some combination thereof. In some embodiments, the request may also be based on criteria, which can correspond to, but not be limited to, user ID, time, date, zone type, zone ID, location type, location ID, and the like, or some combination thereof.

In Step 404, engine 200 can operate to collect network and location data for the device. Such collection can be performed in a similar manner as discussed above respective to Step 304 of Process 300 of FIG. 3, discussed supra. Thus, in Step 404, engine 200 can collect data, which can be stored in database 108, and which can indicate the network activity of the device and the current position within the location. For example, the device, which is identified as corresponding to an 8 year old child user's tablet, requested to open their YouTube Kids® application when the user is in their room.

In Step 406, engine 200 can retrieve the 3D data structure for the location. Such data structure, as discussed above at least in relation to Process 300 of FIG. 3, can be retrieved upon receiving the request in Step 402 and/or upon collecting the network and location data in Step 404. Such retrieval, for example, can involve a query of database 108 for the 3D data structure of the location identified in the request.

In Step 408, engine 200 can analyze the collected network and location data in view of the 3D data structure for the location. Such computational analysis can be performed via execution of the AI/ML models discussed at least in relation to Steps 306-308 of Process 300, discussed supra.

In Step 410, engine 200 can determine a positional mapping of the user device within the 3D mapping of the location. Such determination, which is based on the analysis in Step 408, can determine where the user device is within the zone configuration of the 3D mapping of the location, for example. For example, the user device, being within the user's room, can be determined to be within zone 1 of the location, for which policies and controls can be enacted, as discussed below.

In Step 412, engine 200 can determine policies and/or controls (e.g., parental controls) that correspond to a position of the user device as indicated by the positional mapping. For example, for zone 1, policy X and/or parental control Y can be implemented to prevent the user from opening the requested application (e.g., because they are not allowed to watch such content alone (not other occupant in their room) and/or in their room.

According to some embodiments, such types of policies and controls can be implemented to monitor and control the activity of the user device on/connected to the WiFi network at the location. Such policies and/or controls, for example, can utilize router settings to establish access schedules, limiting when specific devices can connect to the internet. Such policies/controls can involve content filtering options that allow blocking of inappropriate websites or categories of content. In some embodiments, QoS settings can be set that can prioritize bandwidth for essential activities while limiting data-intensive applications. Also, in some embodiments, parental controls to set time limits, filter content, and view browsing history for connected devices.

In some embodiments, the policies/controls, as detected in Step 412, can provide solutions that can include, but not be limited to, network monitoring to track data usage, detect potential security threats, and provide detailed reports on online activities, among other types of device identification and control. In some embodiments, guest networks or other types of sub-networks can be created per zone, which may have restricted network access. In some embodiments, MAC address filtering can be employed to control which specific devices are allowed to connect to the network and/or in what manner or privileges are provided thereto.

In Step 414, engine 200 can compile instructions for controlling the user device and/or the user device's network activity. Such instructions, which can be executable by a cloud device, AP device and/or the user device, as per the operational configuration of engine 200, can be compiled as a file for which the corresponding policy/controls (as in Step 412) can be implemented. Thus, in Step 416, the executable file of the instructions can be output as a response to the request (from Step 402), which can cause the execution of the instructions.

Thus, for example, the user's device, upon output of the response to the request, can block the YouTube Kids application from opening on the user's device. In some embodiments, such output response may cause a notification to be sent to another user and/or the service provider (e.g., the parent). For example, such notification may comprise a rendering that can visualize the user device within the location at its position, with interactive information indicating the network resource it is attempting to access.

And, in Step 416, engine 200 can continue monitoring for network and location data, which can be performed in a similar manner as discussed above in Step 404. Such monitoring can enable continued network and/or device performance monitoring of the user device so that appropriate policies and/or controls can be applied to the requested actions of the user device while it is within reach of connectivity of the location's WiFi network.

Accordingly, via the operations of Processes 300 and 400 of FIGS. 3 and 4, respectively, the disclosed framework can provide functionality for leveraging monitored and/or determined spatial awareness related to users and/or their devices in order to create intelligent network-based zones for which network management and/or connectivity can be provided, controlled and managed. The disclosed spatially intelligent zones can correspond to and/or be subject to applied network policies and/or parental controls, for which network activity within such zones can be managed and controlled. Accordingly, the disclosed framework can provide dynamic network capabilities and functionality based on the current position of the user within a location.

FIG. 7 is a schematic diagram illustrating a client device showing an example embodiment of a client device that may be used within the present disclosure. Client device 700 may include many more or less components than those shown in FIG. 7. However, the components shown are sufficient to disclose an illustrative embodiment for implementing the present disclosure. Client device 700 may represent, for example, UE 102 discussed above at least in relation to FIG. 1.

As shown in the figure, in some embodiments, Client device 700 includes a processing unit (CPU) 722 in communication with a mass memory 730 via a bus 724. Client device 700 also includes a power supply 726, one or more network interfaces 750, an audio interface 752, a display 754, a keypad 756, an illuminator 758, an input/output interface 760, a haptic interface 762, an optional global positioning systems (GPS) receiver 764 and a camera(s) or other optical, thermal or electromagnetic sensors 766. Device 700 can include one camera/sensor 766, or a plurality of cameras/sensors 766, as understood by those of skill in the art. Power supply 726 provides power to Client device 700.

Client device 700 may optionally communicate with a base station (not shown), or directly with another computing device. In some embodiments, network interface 750 is sometimes known as a transceiver, transceiving device, or network interface card (NIC).

Audio interface 752 is arranged to produce and receive audio signals such as the sound of a human voice in some embodiments. Display 754 may be a liquid crystal display (LCD), gas plasma, light emitting diode (LED), or any other type of display used with a computing device. Display 754 may also include a touch sensitive screen arranged to receive input from an object such as a stylus or a digit from a human hand.

Keypad 756 may include any input device arranged to receive input from a user. Illuminator 758 may provide a status indication and/or provide light.

Client device 700 also includes input/output interface 760 for communicating with external. Input/output interface 760 can utilize one or more communication technologies, such as USB, infrared, Bluetooth™, or the like in some embodiments. Haptic interface 762 is arranged to provide tactile feedback to a user of the client device.

Optional GPS transceiver 764 can determine the physical coordinates of Client device 700 on the surface of the Earth, which typically outputs a location as latitude and longitude values. GPS transceiver 764 can also employ other geo-positioning mechanisms, including, but not limited to, triangulation, assisted GPS (AGPS), E-OTD, CI, SAI, ETA, BSS or the like, to further determine the physical location of client device 700 on the surface of the Earth. In one embodiment, however, Client device 700 may through other components, provide other information that may be employed to determine a physical location of the device, including for example, a MAC address, Internet Protocol (IP) address, or the like.

Mass memory 730 includes a RAM 732, a ROM 734, and other storage means. Mass memory 730 illustrates another example of computer storage media for storage of information such as computer readable instructions, data structures, program modules or other data. Mass memory 730 stores a basic input/output system (“BIOS”) 740 for controlling low-level operation of Client device 700. The mass memory also stores an operating system 741 for controlling the operation of Client device 700.

Memory 730 further includes one or more data stores, which can be utilized by Client device 700 to store, among other things, applications 742 and/or other information or data. For example, data stores may be employed to store information that describes various capabilities of Client device 700. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 700.

Applications 742 may include computer executable instructions which, when executed by Client device 700, transmit, receive, and/or otherwise process audio, video, images, and enable telecommunication with a server and/or another user of another client device. Applications 742 may further include a client that is configured to send, to receive, and/or to otherwise process gaming, goods/services and/or other forms of data, messages and content hosted and provided by the platform associated with engine 200 and its affiliates.

According to some embodiments, certain aspects of the instant disclosure can be embodied via functionality discussed herein, as disclosed supra. According to some embodiments, some non-limiting aspects can include, but are not limited to the below method aspects, which can additionally be embodied as system, apparatus and/or device functionality:
Aspect 1. A method comprising:
   receiving a request from a user device at a location, the request comprising information indicating a network resource, the user device connected to a network at the location;
   retrieving in response to the request, a mapping of the location, the mapping comprising information related to a topology of the WiFi network and layout of the location;
   determining, based at least on the mapping, a position of the user device within the location;
   determining, based on the position of the user device, a policy, the policy corresponding to a region of the location that the position is within, the policy comprising a configuration for how a device can act on the network; and
   executing the policy, such that the user device is caused to act in compliance with the configuration, the execution of the policy operating to manage a request from the user device for the network resource.
Aspect 2. The method of aspect 1, further comprising:
   collecting, in response to the request, network data and location data for the user device, the collected network data comprising information indicating the network resource, the collected location data corresponding to the position; and
   performing, based further on the collected network data and location data, the determination of the position of the user device within the location.
Aspect 3. The method of aspect 1, wherein the policy corresponds to at least one of a network policy, content policy and parental control, the policy controlling how the user device is capable of accessing the network resource.
Aspect 4. The method of aspect 1, wherein the network resource corresponds to at least one of an application, web page, web site, file, storage, another device and network location.
Aspect 5. The method of aspect 1, further comprising:
   identifying a set of anchor points for the location;
   collecting metrics for a set of devices at the location;
   determining, based on the collected metrics and information related to the set of anchor points, distance and position information of the set of devices;
   determining, based on the determined distance and position information, the mapping of the location; and
   storing, in a database, the mapping.
Aspect 6. The method of aspect 1, wherein the mapping comprising information indicating a set of zones, each zone providing a network configuration as provided by at least one policy, wherein the region corresponds to at least one zone of the location.
Aspect 7. The method of aspect 1, further comprising:
   communicating the mapping to a cloud; and
   performing, by a cloud device, the determination of the position.
Aspect 8. The method of claim 1, wherein the execution of the policy is performed by an access point of the wireless network.
Aspect 9. The method of aspect 1, wherein the caused actions are in compliance with the configuration at least one of: prevent the device from accessing the network resource, enable access to the network resource and modify access to the network resource, wherein the configuration of the policy is modifiable over time based on user configurable parameters.
Aspect 10. The method of aspect 1, further comprising:
   rendering the mapping, such that the user device and network activity of the user device can be depicted within the rendering.
Aspect 11. The method of aspect 1, wherein the mapping is a three-dimensional (3D) mapping.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving a request from a user device at a location, the request comprising information indicating a network resource, the user device connected to a network at the location;
retrieving in response to the request, a mapping of the location, the mapping comprising information related to a topology of the network and layout of the location;
determining, based at least on the mapping, a position of the user device within the location;
determining, based on the position of the user device, a policy, the policy corresponding to a region of the location that the position is within, the policy comprising a configuration for how a device can act on the network; and
executing the policy, such that the user device is caused to act in compliance with the configuration, the execution of the policy operating to manage a request from the user device for the network resource.

2. The method of claim 1, further comprising:
collecting, in response to the request, network data and location data for the user device, the collected network data comprising information indicating the network resource, the collected location data corresponding to the position; and
performing, based further on the collected network data and location data, the determination of the position of the user device within the location.

3. The method of claim 1, wherein the policy corresponds to at least one of a network policy, content policy and parental control, the policy controlling how the user device is capable of accessing the network resource.

4. The method of claim 1, wherein the network resource corresponds to at least one of an application, web page, web site, file, storage, another device and network location.

5. The method of claim 1, further comprising:
identifying a set of anchor points for the location;
collecting metrics for a set of devices at the location;
determining, based on the collected metrics and information related to the set of anchor points, distance and position information of the set of devices;
determining, based on the determined distance and position information, the mapping of the location; and
storing, in a database, the mapping.

6. The method of claim 1, wherein the mapping comprising information indicating a set of zones, each zone providing a network configuration as provided by at least one policy, wherein the region corresponds to at least one zone of the location.

7. The method of claim 1, further comprising:
communicating the mapping to a cloud; and
performing, by a cloud device, the determination of the position.

8. The method of claim 1, wherein the execution of the policy is performed by an access point of the network.

9. The method of claim 1, wherein the caused actions are in compliance with the configuration at least one of: prevent the device from accessing the network resource, enable access to the network resource and modify access to the network resource, wherein the configuration of the policy is modifiable over time based on user configurable parameters.

10. The method of claim 1, further comprising:
rendering the mapping, such that the user device and network activity of the user device can be depicted within the rendering.

11. The method of claim 1, wherein the mapping is a three-dimensional (3D) mapping.

12. A network device comprising:
a processor configured to:
receive a request from a user device at a location, the request comprising information indicating a network resource, the user device connected to a network at the location;
retrieve in response to the request, a mapping of the location, the mapping comprising information related to a topology of the network and layout of the location;
determine, based at least on the mapping, a position of the user device within the location;
determine, based on the position of the user device, a policy, the policy corresponding to a region of the location that the position is within, the policy comprising a configuration for how a device can act on the network; and
execute the policy, such that the user device is caused to act in compliance with the configuration, the execution of the policy operating to manage a request from the user device for the network resource.

13. The network device of claim 12, wherein the processor is further configured to:
collect, in response to the request, network data and location data for the user device, the collected network data comprising information indicating the network resource, the collected location data corresponding to the position; and
perform, based further on the collected network data and location data, the determination of the position of the user device within the location.

14. The network device of claim 12, wherein the policy corresponds to at least one of a network policy, content policy and parental control, the policy controlling how the user device is capable of accessing the network resource.

15. The network device of claim 12, wherein the network resource corresponds to at least one of an application, web page, web site, file, storage, another device and network location.

16. The network device of claim 12, wherein the processor is further configured to:
identify a set of anchor points for the location;
collect metrics for a set of devices at the location;
determine, based on the collected metrics and information related to the set of anchor points, distance and position information of the set of devices;
determine, based on the determined distance and position information, the mapping of the location; and
store, in a database, the mapping.

17. The network device of claim 12, wherein the mapping comprising information indicating a set of zones, each zone providing a network configuration as provided by at least one policy, wherein the region corresponds to at least one zone of the location.

18. The network device of claim 12, wherein the network device is a cloud device.

19. The network device of claim 12, wherein the network device is an access point device.

20. A non-transitory computer-readable storage medium tangibly encoded with computer-executable instructions that when executed by a processor, perform a method comprising steps of:
receiving a request from a user device at a location, the request comprising information indicating a network resource, the user device connected to a network at the location;
retrieving in response to the request, a mapping of the location, the mapping comprising information related to a topology of the network and layout of the location;
determining, based at least on the mapping, a position of the user device within the location;
determining, based on the position of the user device, a policy, the policy corresponding to a region of the location that the position is within, the policy comprising a configuration for how a device can act on the network; and
executing the policy, such that the user device is caused to act in compliance with the configuration, the execution of the policy operating to manage a request from the user device for the network resource.
